(19) United States
(12) Patent Application Publication
(10) Pub. No.: US 2016/0106263 A1
(43) Pub. Date: Apr. 21, 2016

(54) Kitchen appliance comprising cooling device

(71) Applicant: Vorwerk & Co. Interholding GmbH, Wuppertal (DE)

(72) Inventor: Uwe HEIDER, Huerth (DE)

(73) Assignee: VORWERK & CO. INTERHOLDING GMBH, Wuppertal (DE)

(21) Appl. No.: 14/887,607

(22) Filed: Oct. 20, 2015

(30) Foreign Application Priority Data
Oct. 21, 2014 (DE) 10 2014 115 322.7

(51) Int. Cl. A47J 43/046

(52) U.S. Cl. CPC A47J 43/046

(57) ABSTRACT

The invention relates to a kitchen appliance (1), in particular a mixer, comprising a housing (2), a heat source (3), in particular a motor or a device electronics, and a cooling device (4). To avoid contamination of the kitchen appliance (1) and to attain an improved sound absorption, it is proposed for the heat source (3) to be connected to a heat exchanger element (5) of the cooling device (4), which is arranged separately from this heat source (3) and which forms a partial area of an outer surface of the housing (2), wherein the heat exchanger element (5) is embodied in such a manner that it can emit heat, which is to be discharged from the heat source (3), into the environment by means of natural convection

The invention relates to a kitchen appliance, in particular a mixer, comprising a housing, a heat source, in particular a motor or a device electronics, and a cooling device.

Kitchen appliances of the type in question are known, thus in particular in the form of kitchen appliances, which are driven by electric motor, for the household sector, for example so-called cooking mixers. Such kitchen appliances have a vessel, which can preferably be removed from the main appliance housing, in particular a mixing vessel, in which a mixing unit can be arranged, for example on the bottom side. The mixing unit can be driven via an electric motor, which is provided on the appliance side and which can be coupled to the mixing unit. Such a kitchen appliance is disclosed in publication DE 10 2010 017 335 A1.

In addition, it is also known in the prior art to provide cooling devices for such kitchen appliances. These cooling devices have a cooling fan, for example, which sucks in ambient air outside of the kitchen appliance and guides it to the heat-generating elements, for example the motor or the device electronics, for cooling purposes. So that the cooling air can enter the kitchen appliance and can escape from the latter again after the cooling process, the housing has suction openings and exhaust openings.

In addition, cooling devices for kitchen appliances are also known, with the help of which a vessel, or food contained in the vessel, respectively, can be cooled. WO 2007/135130 A1, for example, relates to a kitchen appliance for preparing ice cream by means of a vessel, which is suitable for freezing the content thereof and to the wall of which a first Peltier element is assigned for generating cold. This Peltier element is actively cooled on the hot side thereof by means of a heat transfer medium, wherein this heat transfer medium, in turn, is guided in a separate cooling cycle, and wherein a separate second Peltier element is, in turn, assigned to the cooling cycle. The cold side of the second Peltier element faces the cooling cycle, while the hot side is provided with cooling fins.

In the case of the afore-mentioned cooling devices, disadvantages result in that, for discharging the heat of at least the second Peltier element from the housing of the kitchen appliance, suction openings or exhaust openings, respectively, are required, through which dust and dirt can enter the kitchen appliance and can deposit there. In addition, cooling fans, which might be present, and the air flow associated therewith creates a background noise of the kitchen appliance, which can escape from the housing through the suction and exhaust openings.

It is thus the object of the instant invention to create a kitchen appliance comprising a cooling device, in the case of which the afore-mentioned disadvantages of the contamination or of the sound emission, respectively, are avoided.

To solve the afore-mentioned object, the invention proposes a kitchen appliance, in the case of which the heat source is connected to a heat exchanger element of the cooling device, which is arranged separately from this heat source and which forms a partial area of an outer surface of the housing, wherein the heat exchanger element is embodied in such a manner that it can emit heat, which is to be discharged from the heat source, into the environment by means of natural convection.

The kitchen appliance according to the invention forgoes the use of a cooling fan and uses heat exchanger elements, which discharge the heat of the heat source, without thereby forcing an air flow. The heat discharge from the heat source takes place exclusively by means of natural convention and/or heat conduction. In particular, the heat exchanger element forms a part of an outer surface of the housing, which is in direct contact with the ambient air. Suction openings and/or exhaust openings inside the housing of the kitchen appliance are not required. Dust or dirt is thus prevented or is reduced, respectively, from entering the kitchen appliance. By eliminating a cooling fan or the forced air flow associated therewith, respectively, the housing emission of the kitchen appliance is reduced additionally.

According to the invention, the heat discharge takes place starting in the warm areas inside the kitchen appliance, namely the heat sources, in the direction of an outer surface of the housing. The heat exchanger element can form a partial area of the bottom of the machine housing, for example, or, in the alternative also a wall. It does not need to be considered that suction/exhaust openings are exposed.

For example, the heat exchanger element can have a metal plate. Advantageously, this metal plate has a heat conductivity, which is as large as possible, so that in particular the use of aluminum or copper plates is advisable. The metal plate can be a flat plate. Preferably, said plate is equipped with cooling fins, if applicable, so as to increase the effective heat-exchanging surface.

It is proposed for the heat exchanger element to be embodied in a housing-shaped manner, in particular as a cup, which is open on one side, wherein the heat source is at least partially surrounded by the housing-shaped heat exchanger element. By means of this embodiment, a plurality of partial surfaces of the heat exchanger element are adjacent to the heat source, so that the heat can be transferred similarly well to the heat exchanger element from several sides. In the event that the heat source is a motor, for example, the heat exchanger element can be adapted to the shape of the heat source, so that the distance between the heat source and the surfaces of the heat exchanger element is particularly small.

According to the invention, at least a partial area of the heat exchanger element, for example a surface of the housing-shaped heat exchanger element, forms a part of an outer surface of the housing. The housing surface as part of the housing thereby takes over the function of limiting the kitchen appliance on the one hand and the function of a heat exchanger element on the other hand. On the one hand, this saves material and, on the other hand, an optimal heat dissipation, starting at the inner area of the housing of the kitchen appliance to the outside, is attained. It is possible for the bottom and/or for one or a plurality of walls of the housing, for example, to be formed by a heat exchanger element. The larger the surface, the better the performance of the heat exchanger element.

It is proposed for the heat source to be connected to the heat exchanger element by means of a heat-transferring element, in particular by means of a heat-conducting element or a heat pipe. According to this embodiment, an effective transfer of the heat from the heat source to the heat exchanger element is possible regardless of the distance between heat source and heat exchanger element. An air layer, which might be insulating, between the heat source and the heat exchanger element is bridged in that a heat-transferring element is provided. This heat-transferring element can be a heat conductor comprising a large heat conductivity, such as gold, silver or copper, for example. For example, webs produced from such a material can be arranged on the heat-generating element on the one hand and on the heat exchanger element on the other hand. In the alternative, the use of a heat pipe as heat-transferring element is advisable. The heat pipe is filled with a working medium, such as water or ammonia, for example, a small part of which is present in liquid state and a larger part of which is present in a vaporous state. The heat pipe has heat transfer surfaces, which are connected to the heat source, for example to the motor and the heat exchanger element. In response to heat input through the heat source, the working medium evaporates. The pressure in the vapor space of the heat pipe is increased locally through this, which leads to a pressure drop inside the heat pipe. The steam thus flows in the direction of the heat sink (heat exchanger element), where it condensates due to the low temperature. The heat is thereby emitted to the heat exchanger element and is exchanged with the ambient air. The working medium, which is now in the liquid state, returns to its initial position, that is, into the area of the heat source by means of capillary forces. By using the evaporation heat of the working medium, the heat pipe allows for a large heat flux density, that is, large quantities of heat can be transported on a small cross sectional surface. The heat can thus be transported away from the heat source of the kitchen appliance in an optimal manner.

In terms of the invention, provision can be made for the cooling device to be an absorption refrigeration comprising an evaporator, a liquefier and at least one heating element, wherein the evaporator and the liquefier are parts of the heat exchanger element. According to this embodiment, the cooling of the heat source of the kitchen appliance takes place according to the principle of an absorber cooling. The advantages of a heat cycle are used thereby, without having to simultaneously use a sound-generating compressor. The absorption refrigeration removes heat from the heat source of the kitchen appliance, such as the motor and/or the device electronics, for example, and conveys it into the environment.

Advantageously, the absorption refrigeration works with a water-ammonia mixture. The water-ammonia mixture is separated into ammonia and water by exposing it to heat energy. Directly after turning on the kitchen appliance, the heat source (motor, electronics) is not yet sufficiently warm, so that the required heat energy is provided by means of a separate heating element. The liquid water and the gaseous ammonia are subsequently transferred via different pipe systems, wherein the ammonia is liquefied again by means of the liquefier. The heat released in response to the condensation is emitted to the environment, for example by means of a heat exchanger element, which forms a part of the outer surface of the housing of the kitchen appliance. The ammonia is subsequently reunited with the water, so that a cooling process can be triggered by heating the ammonia-water mixture by means of the heat from the heat source. As soon as the heat source is heated accordingly, it provides the heat for the evaporation process, so that the separate heater can be turned off. The evaporator provided in the area of the heat source extracts the heat, which is required for the evaporation of the ammonia, from the heat source. The heat source is thus cooled. It is particularly advantageous thereby that moved parts do not need to be used for the absorption refrigeration. The heat cycle virtually operates soundlessly in this regard.

The separate heating element can be an induction heater, a resistance heater or also a Peltier element. As explained above, this is to be provided for the start-up phase of the evaporation process, in which the heat source, for example the motor or the device electronics, still do not have a sufficient temperature for effecting the separation of the water-ammonia mixture. It is advisable in this regard for the heating element of the absorption refrigeration to heat independently in the start-up phase of the evaporation process and is turned off after a sufficient heating of the heat source.

Advantageously, the liquefier and/or the evaporator is embodied in a tubular manner. Due to this embodiment, the heat exchanger element provides pipes for guiding the ammonia or water, respectively, on the one hand and, on the other hand, works as cylindrical heat exchanger element, which is able to emit the heat of the medium contained therein into the environment. The liquefier, which releases heat during the condensation process, advantageously forms a part of an outer surface of the housing of the kitchen appliance, so that the heat can be transferred to the ambient air in a particularly effective manner.

Finally, it is proposed for the evaporator to be assigned to a vessel of the kitchen appliance in such a manner that food, which is contained in the vessel, can be cooled. In this regard, the cooling device is not only a cooling device for cooling one or a plurality of heat sources, as for example motor and device electronics of the kitchen appliance, but instead also (in the alternative or additionally) a device for cooling food contained in a vessel. In this'regard, the kitchen appliance as a whole can also be used to produce foods, which need to be cooled, for example ice cream. The kitchen appliance can also be used to store food, which requires to be cooled, for a short period of time. The cooling device according to the invention for a kitchen appliance can thus cool different elements of the kitchen appliance, on the one hand the heat source, on the other hand also a vessel of the kitchen appliance.

In addition, it is also advisable to operate the cooling device according to the invention in combination with an induction heater, which is provided for heating the vessel, so that the heat deflection of the kitchen appliance to the outside is very small as a whole.

The invention will be specified below in more detail by means of two exemplary embodiments:

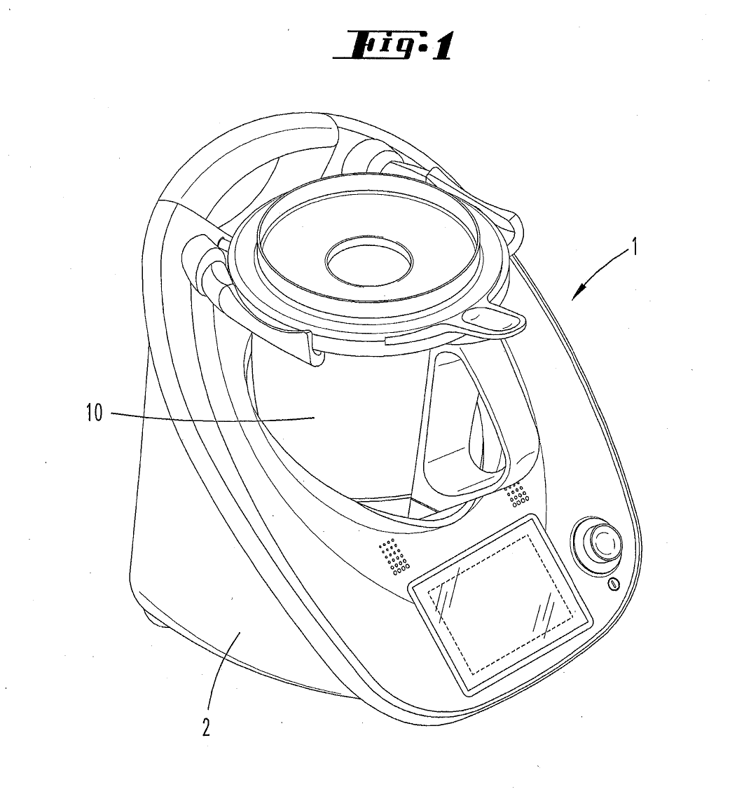

FIG. 1 shows a generic kitchen appliance in a perspective view,

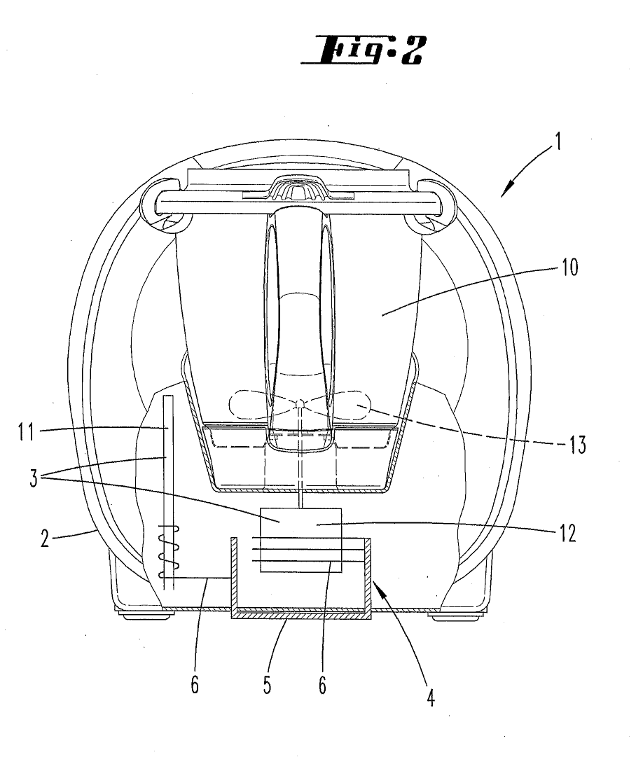

FIG. 2 shows the kitchen appliance in a first embodiment (sectional illustration),

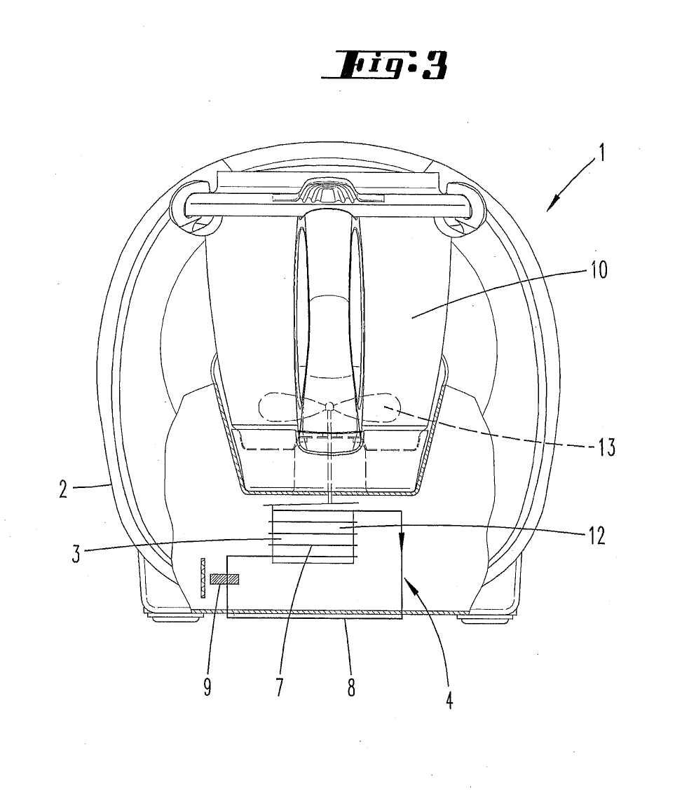

FIG. 3 shows the kitchen appliance in a second embodiment (sectional illustration.

The shown kitchen appliance 1 is embodied in an exemplary manner as cooker-mixer, but, on principle, it can be any type of kitchen appliance, which has heat sources, such as an electric motor, for example.

The kitchen appliance 1 has a housing 2, in which provision is made for a receptacle for a vessel 10, a motor 12, a mixing unit 13 and the like, for example. In addition, provision can also be made in the housing 2 for a display, a control panel and the like.

A vessel 10, which is inserted into a vessel receptacle of the housing 2 here, is assigned to the kitchen appliance 1. The mixing unit 13, which is operated via the motor 12 arranged in the kitchen appliance 1 below the vessel receptacle, as well as via an electronics 11 (heat sources 3), is assigned to the vessel 10.

According to the exemplary embodiment shown in FIG. 2, the kitchen appliance 1 has at least two heat sources 3, namely the motor 12 and an electronics 11. A cooling device 4, which has a heat exchanger element 5 as well as two heat-transferring elements 6, is assigned to the heat sources 3. The heat exchanger element 5 is embodied in a housing-shaped manner, namely in a cup-shaped manner, wherein the heat source 3, namely the motor 12, is partially surrounded thereby. The bottom area of the housing-shaped heat exchanger element 5 forms a part of an outer surface of the housing 2 of the kitchen appliance 1. The heat exchanger element 5 thereby reaches through the bottom area of the housing 2 of the kitchen appliance 1. The heat exchanger element 5 substantially consists of flat metal plates, which are connected to one another, in particular welded, in the form of a cup. A heat-transferring element 6, which is embodied as heat pipe here, is arranged in each case between the heat exchanger element 5 and the heat sources 3. The heat-transferring element 6 thereby advantageously contacts the heat source 3 along a surface, which is as large as possible. It is advisable in particular for the heat-transferring element 6 to be guided around the heat source 3 in a loop-shaped or spiral-shaped manner.

The cooling device 4 according to FIG. 2 works in such a manner that, in response to the preparation of a food inside the vessel 10 of the kitchen appliance 1, heat is generated at the heat sources 3, namely the motor 12 and the electronics 11. This heat is transferred to the cooling device 4 via the contact points between the heat sources 3 and the heat-transferring elements 6, namely the heat pipes. According to their embodiment as heat pipe, the heat-transferring elements 6 include a working medium, which is evaporated by the heat sources 3 due to the heat input. As a result, the pressure inside the pipe rises, which leads to a pressure drop along the pipe. The steam then flows in the direction of the end of the heat-transferring element 6, which faces away from the heat source 3, namely into the area of the heat exchanger element 5. Due to its temperature, which is lower as compared to the heat source, 3, the heat exchanger element 5 works as heat sink, so that the steam contained in the heat pipe condenses. The previously absorbed heat is thereby released into the ambient air of the heat exchanger element 5. The working medium returns into the area of the heat sources 3 by means of capillary forces. If a partial area of the heat exchanger element 5 is made of a metal, for example, comprising a particularly high heat conductivity, in particular copper or aluminum, the cooling device 4 is particularly efficient.

According to the exemplary embodiment illustrated in FIG. 3, the kitchen appliance 1 has a cooling device 4, which includes an evaporator 7, a liquefier 8 and a heating element 9. As a whole, the cooling device 4 is embodied as absorption refrigeration. The evaporator 7 is arranged in the area of the heat source 3, here a motor 12, wherein the evaporator 7 is embodied in a tubular manner and is guided around the heat source 3 in a spiral manner, The evaporator 7 is connected to the liquefier 8, which forms a part of an outer surface of the housing 2 of the kitchen appliance 1. The heating element 9 arranged in the absorption cooling cycle of the cooling device 4, is a separate heating element, which works independent from the heat of the heat source 3.

The cooling device 4 provides an absorption cooling cycle, which works in such a manner that the working medium, which is located in the pipe system of the cycle and which is a water-ammonia mixture here, is heated by means of the heating element 9. The heating element 9 can be embodied as induction heater, for example. As a result of the heating of the working medium, ammonia and water are separated from one another and are subsequently transferred via different pipe systems. At one point in time, at which the heat source 3, namely here the motor 12, generates sufficient heat, the separate heating element 9 can be turned off and the water-ammonia mixture can be heated by the exhaust heat of the heat source 3 itself. In a subsequent step, the ammonia is liquefied in the liquefier 8. The liquefier 8 thereby emits heat into the environment. The ammonia is subsequently evaporated again by means of the evaporator 7, so that the heat source 3, which is arranged in the area of the evaporator 7, is cooled. According to a further embodiment, it would be possible to forego the separate heating element 9 completely. According to this embodiment alternative, the cooling device 4 only works, when the heat sources 3 of the kitchen appliance 1, that is, the motor 12, electronics 11 and similar heat-generating elements, are heated sufficiently for operating the absorption cooling cycle of the cooling device 4.

### LIST OF REFERENCE NUMERALS

1 kitchen appliance
2 housing
3 heat source
4 cooling device
5 heat exchanger element
6 heat-transferring element
7 evaporator
8 liquefier
9 heating element
10 vessel
11 electronics
12 motor
13 mixing unit

1: A kitchen appliance (1), in particular a mixer, comprising a housing (2), a heat source (3), in particular a motor or a device electronics, and a cooling device (4), wherein the heat source (3) is connected to a heat exchanger element (5) of the cooling device (4), which is arranged separately from this heat source (3) and which forms a partial area of an outer surface of the housing (2), wherein the heat exchanger element (5) is embodied in such a manner that it can emit heat, which is to be discharged from the heat source (3), into the environment by means of natural convection.

2: The kitchen appliance (1) according to claim 1, wherein the heat exchanger element (5) has a metal plate.

3: The kitchen appliance (1) according to claim 1, wherein the heat exchanger element (5) is embodied in a housing-shaped manner, in particular as a cup, which is open on one side, wherein the heat source (3) is at least partially surrounded by the housing-shaped heat exchanger element (5).

4: The kitchen appliance (1) according to claim 1, wherein the heat source (3) is connected to the heat exchanger element (5) by means of a heat-transferring element (6), in particular a heat-conducting element or a heat pipe.

5: The kitchen appliance (1) according to claim 1, wherein the cooling device (4) is an absorption refrigeration comprising an evaporator (7), a liquefier (8) and at least one heating element (9), wherein the evaporator (7) and the liquefier (8) are parts of the heat exchanger element (5).

6: The kitchen appliance (1) according to claim 5, wherein the heating element (9) is a separate element, which is independent from the heat source (3).

7: The kitchen appliance (1) according to claim 5, wherein the liquefier (8) and/or the evaporator (7) is embodied in a tubular manner.

8: The kitchen appliance (1) according to claim 5, wherein the evaporator (7) is assigned to a vessel (10) of the kitchen appliance (1) in such a manner that food, which is contained in the vessel (10), can be cooled.
